(19) United States
(12) Patent Application Publication
(10) Pub. No.: US 2007/0064291 A1
(43) Pub. Date: Mar. 22, 2007

(54) Optical scanning apparatus

(75) Inventor: Hideki Kashimura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/404,830

(22) Filed: Apr. 17, 2006

(30) Foreign Application Priority Data
Sep. 16, 2005 (JP) 2005-271062

(51) Int. Cl. G02B 26/08

(52) U.S. Cl. 359/204; 359/212

(57) ABSTRACT

An optical scanning apparatus includes a light source, which emits plural light beam groups from plural liminous points which are two-dimensionally arranged in a grid form; a pre-deflection optical system, which transmits the plural light beam groups emitted from the light source; and a deflector, which reflects the plural light beam groups which have been transmitted through the pre-deflection optical system at a deflection surface, for scanningly deflecting the plural light beam groups in a main scanning direction. The pre-deflection optical system includes a first incidence angle-adjuster for adjusting sub-scanning direction incidence angles of the light beam groups which are incident at the deflection surface of the deflector.

### CROSS-REFERENCE TO RELATED APPLICATION

This application claims priority under 35 USC 119 from Japanese Patent Application No. 2005-271062, the disclosure of which is incorporated by reference herein.

### BACKGROUND

1. Technical Field

The present invention relates to an optical scanning apparatus.

2. Related Art

Heretofore, an optical scanning apparatus has been known which, in a tandem-system color laser printer or the like, separates plural laser beams, which have been emitted from a single light source and deflected by a single deflector, and scans plural photosensitive bodies therewith.

An optical scanning apparatus has also been known which, with a view to increasing printing speed and/or raising resolution of color images, separates a total of eight laser beams, which have been emitted from a multi-laser beam array at which four groups of point light sources structured by respective pairs of point light sources are provided, into four laser beam groups of two beams each, and scans four photosensitive bodies therewith.

As such an optical scanning apparatus, an optical scanning apparatus has been proposed in which a sub-scanning direction spacing of plural scanning beams on a photosensitive body is adjusted by turning a light source about an optical axis to provide the light source with a suitable angle.

However, in order to separate plural laser beams emitted from a single light source at such a structure, it is necessary to provide a predetermined spacing between the plural laser beams at a location at which the laser beams are to be separated into laser beam groups. Accordingly, a pre-deflection optical system is made to be telecentric, or a predetermined angle is provided in the sub-scanning direction, which intersects a deflection surface. However, because of focusing distance errors of the pre-deflection optical system, errors arise in oblique angles of incidence on the deflection surface of the deflector (see FIG. 4). Hence, because of such errors in the oblique incidence angles, scanning lines on a photosensitive body are curved into arcs, and “bowing” occurs (see FIG. 8). Moreover, in a case in which plural laser beams are scanned in the same scan, curvature amounts thereof differ for each of the laser beams, spacings of the laser beams in the sub-scanning direction vary with scanning positions in a main scanning direction, and a “bow difference” occurs (see FIG. 10A).

### SUMMARY

According to an aspect of the present invention, an optical scanning apparatus includes: a light source, which emits plural light beam groups from plural light source points which are two-dimensionally arranged in a grid form; a pre-deflection optical system, which transmits the plural light beam groups emitted from the light source; and a deflector, which reflects the plural light beam groups which have been transmitted through the pre-deflection optical system at a deflection surface, for scanningly deflecting the plural light beam groups in a main scanning direction, wherein the pre-deflection optical system includes a first incidence angle-adjuster, for adjusting sub-scanning direction incidence angles of the light beam groups which are incident at the deflection surface of the deflector.

### BRIEF DESCRIPTION OF THE DRAWINGS

Exemplary embodiments of the present invention will be described in detail based on the following figures, wherein:

FIG. 1 is a perspective view showing structure of an optical scanning apparatus of a first exemplary embodiment of the present invention;

FIG. 2 is a schematic view showing the optical scanning apparatus of the first exemplary embodiment of the present invention;

FIG. 3A is a plan view showing a light source of the optical scanning apparatus of the first exemplary embodiment of the present invention;

FIG. 3B is a plan view showing a photosensitive body of the first exemplary embodiment of the present invention;

FIG. 4 is a view of a cylindrical lens viewed in a cross-section along a sub-scanning direction;

FIG. 5 is a diagram schematically showing a change in sub-scanning direction incidence angles at a deflection surface due to movement of the cylindrical lens in an optical axis direction;

FIG. 6A is an exploded perspective view showing a cylindrical lens-moving mechanism;

FIG. 6B is a plan view showing the cylindrical lens-moving mechanism;

FIG. 7 is a view showing a light source-turning mechanism;

FIG. 8 is an explanatory view for explaining curvature of a scanning line;

FIG. 9 is a view schematically showing a situation in which curvature amounts of scanning lines are adjusted;

FIG. 10A is a view showing a state in which curvature amounts of scanning lines differ and a bow difference arises;

FIG. 10B is a view showing a state in which curvature amounts of scanning lines are eliminated and the bow difference is eliminated;

FIG. 11 is a plan view schematically showing an optical scanning apparatus of a second exemplary embodiment of the present invention;

FIG. 12 is a diagram schematically showing a situation in which a reflection mirror of the optical scanning apparatus of the second exemplary embodiment of the present invention is turned and an incident angle at a deflection surface is adjusted;

FIG. 13 is a plan view schematically showing an optical scanning apparatus of a third exemplary embodiment of the present invention; and

FIG. 14 is a view showing a reflection mirror angle-adjusting mechanism.

### DETAILED DESCRIPTION

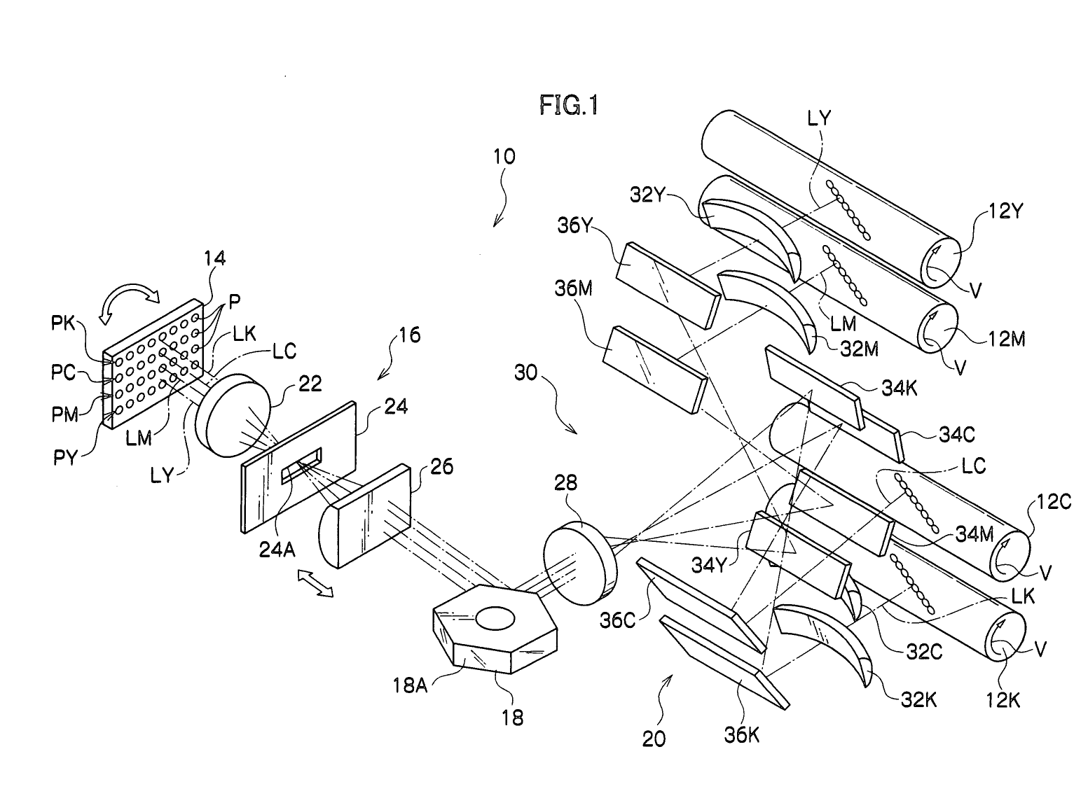

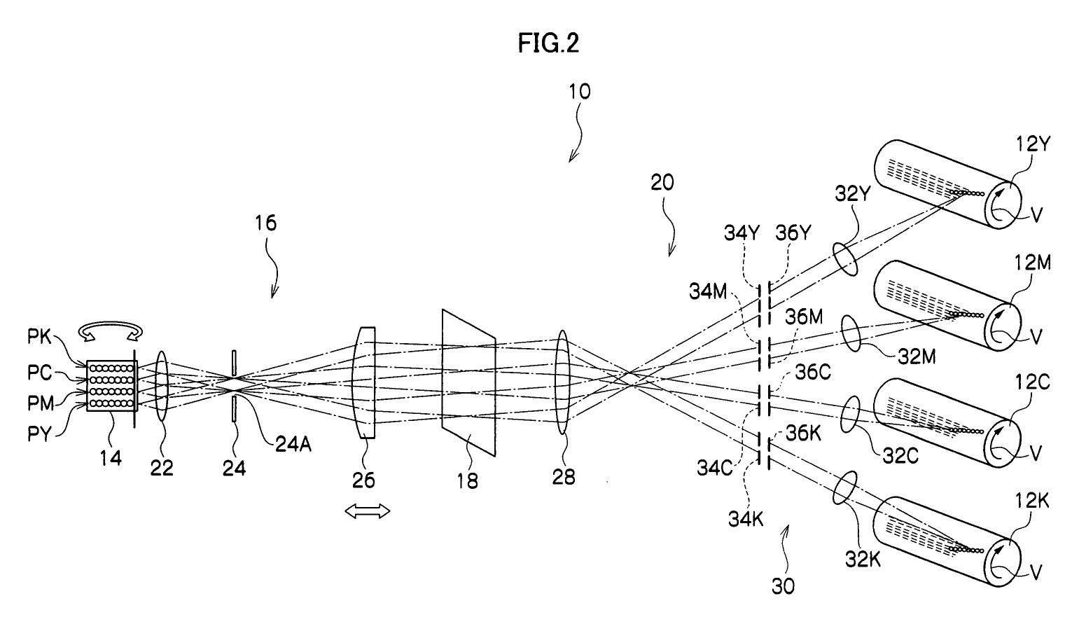

In FIGS. 1 and 2, a color laser printer is equipped with an optical scanning apparatus 10 of a first exemplary embodiment of the present invention. The optical scanning apparatus 10 irradiates laser beam groups LY, LM, LC and LK, which respectively serve as light flux groups, at photosensitive bodies 12Y, 12M, 12C and 12K, which each rotate in the direction of arrow V, to form latent images. The latent images formed at the photosensitive bodies 12Y, 12M, 12C and 12K are developed by unillustrated developing units of the respective colors, to form toner images of yellow (Y), magenta (M), cyan (C) and black (K), respectively. The respective toner images on the photosensitive bodies 12Y, 12M, 12C and 12K are transferred to be mutually superposed on an unillustrated intermediate transfer body, to form a full-color toner image. Then, the full-color toner image on the intermediate transfer body is transferred by a single operation to a recording medium, such as ordinary paper or the like.

Hereafter, where Y, M, C and K are to be distinguished, descriptions will be given with ‘Y’, ‘M’, ‘C’ and/or ‘K’ appended to reference numerals, and where Y, M, C and K are not to be distinguished, ‘Y’, ‘M’, ‘C’ and ‘K’ will be omitted.

The optical scanning apparatus 10 is structured with a light source 14, a pre-deflection optical system 16, a rotating polygon mirror 18 which serves as a deflector, and a scanning optical system 20. The four laser beam groups LY, LM, LC and LK are emitted from the single light source 14 with spacings therebetween in a sub-scanning direction (to be described below), and the laser beam groups LY, LM, LC and LK are separated and are focused and scanned onto the four photosensitive bodies 12Y, 12M, 12C and 12K.

At each photosensitive body 12, the direction of an axis of rotation is a main scanning direction and the direction of rotation is the sub-scanning direction. Further, a direction of deflective scanning due to rotation of the rotating polygon mirror 18 of the optical scanning apparatus 10 is a direction corresponding to the main scanning direction, and a direction intersecting the deflective scanning direction is a direction corresponding to the sub-scanning direction.

The light source 14 is a surface emission laser beam array in which 32 light emission points P, in eight rows by four columns, are two-dimensionally arranged in a grid form in the main scanning direction and the sub-scanning direction.

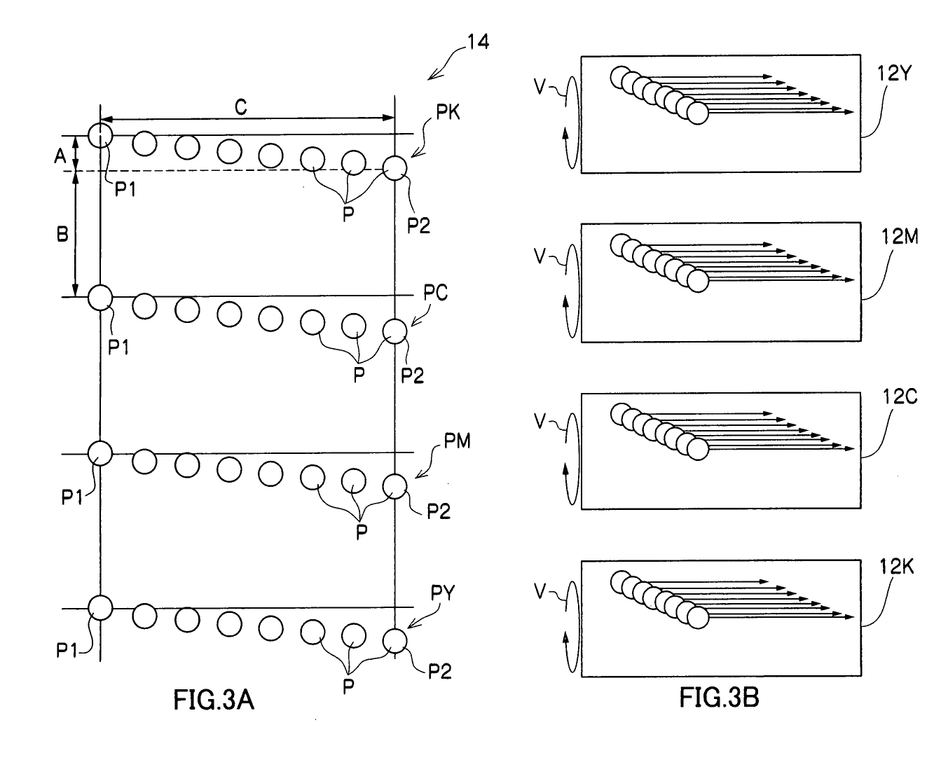

As shown in FIG. 3A, at the light source 14, four light emission point groups PK, PC, PM and PY, each of which is structured by eight light emission points P, are arranged in the sub-scanning direction. Each light emission point group is structured by the eight light emission points P, which are arranged in a straight line which is angled with respect to the main scanning direction and the sub-scanning direction. The light emission point groups PK, PC, PM and PY emit the laser beam groups LK, LC, LM and LY, respectively.

As shown in FIG. 3B, each of the laser groups LY, LM, LC and LK is constituted by eight laser beams, and the eight laser beams simultaneously scan the photosensitive body 12 corresponding to the respective color.

Hereafter, the laser beam groups may be referred to as ‘laser beam groups LY-K’, and may be referred to as ‘laser beam(s) L’.

As shown in FIGS. 1 and 2, the pre-deflection optical system 16 is structured with a coupling lens 22, an aperture 24 and a cylindrical lens 26, which are used in common for the four laser beam groups LY-K. The coupling lens 22 is disposed facing the light source 14. The aperture 24 is provided at a back side focusing position of the coupling lens 22. The cylindrical lens 26 is disposed with a front side focusing position thereof coinciding with an opening 24A of the aperture 24. Here, the cylindrical lens 26 has no power in the main scanning direction and positive power in the sub-scanning direction.

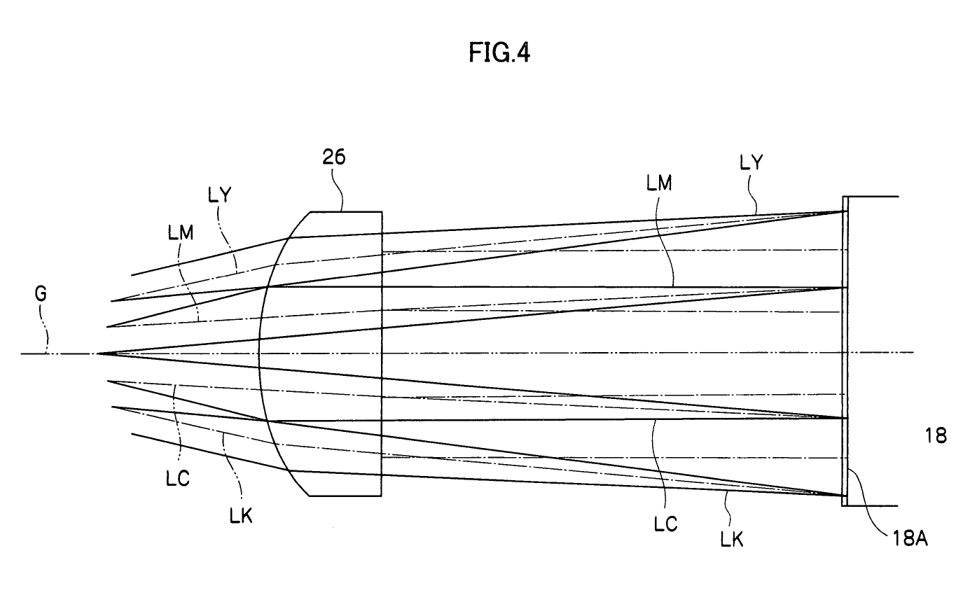

The laser beam groups LY-K emitted from the light source 14 are condensed by the coupling lens 22, pass through the opening 24A of the aperture 24 while being truncated, are condensed by the cylindrical lens 26 only in a direction corresponding to the sub-scanning direction, as shown in FIG. 4, and are incident at a deflection surface 18A of the rotating polygon mirror 18.

As shown in FIG. 1, the rotating polygon mirror 18 features six of the deflection surface 18A, and rotates at a speed of 30,000 rpm. Thus, scanning lines are formed at the photosensitive bodies 12Y, 12M, 12C and 12K. Here, as described earlier, the direction of deflective scanning due to the rotation of the rotating polygon mirror 18 is a direction corresponding to the main scanning direction, and a direction intersecting the deflective scanning direction is a direction corresponding to the sub-scanning direction.

The scanning optical system 20 is structured by an anamorphic aspherical lens 28, through which the laser beam groups LY-K pass, a plane mirror group 30, which serves as a separating section, and toroidal lenses 32Y, 32M, 32C and 32K, which are provided one for each of the laser beam groups LY-K. The aspherical lens 28 and each toroidal lens 32 together have positive power.

The aspherical lens 28 is disposed on an optical path of the laser beam groups LY-K which have been deflected by the rotating polygon mirror 18. A sub-scanning direction focusing length of the aspherical lens 28 is 60 mm, and a distance of the aspherical lens 28 from the deflection surface 18A is also 60 mm. Hence, the respective laser beam groups LY-K intersect at a back side focusing position of the aspherical lens 28 and are incident at the plane mirror group 30. Each laser beam L is formed of substantially parallel light.

The aspherical lens 28 is structured so as to co-operate with the toroidal lenses 32Y, 32M, 32C and 32K to provide f-θ characteristics with respect to the main scanning direction.

The plane mirror group 30 is structured by first plane mirrors 34Y, 34M, 34C and 34K and second plane mirrors 36Y, 36M, 36C and 36K, which are provided for the laser beam groups LY-K, respectively.

The first plane mirrors 34Y, 34M, 34C and 34K reflect the laser beam groups LY-K which are incident at the plane mirror group 30 in negative directions. The second plane mirrors 36Y, 36M, 36C and 36K reflect the laser beam groups LY-K that have been reflected by the first plane mirrors 34Y, 34M, 34C and 34K towards the respective photosensitive bodies 12.

The first plane mirrors 34Y, 34M, 34C and 34K are disposed at positions which are separated by 300 mm from the aspherical lens 28. Sub-scanning direction spacings of the laser beam groups LY-K at these positions are 2.8 mm. Thus, space in which the first plane mirrors 34Y, 34M, 34C and 34K are to be disposed can be thoroughly assured.

The toroidal lenses 32Y, 32M, 32C and 32K focus the respective laser beam groups LY-K that have been reflected by the second plane mirrors 36Y, 36M, 36C and 36K onto the respective photosensitive bodies 12 with predetermined spacings in the sub-scanning direction. Further, as mentioned above, the toroidal lenses 32Y, 32M, 32C and 32K feature f-θ characteristics in combination with the aspherical lens 28.

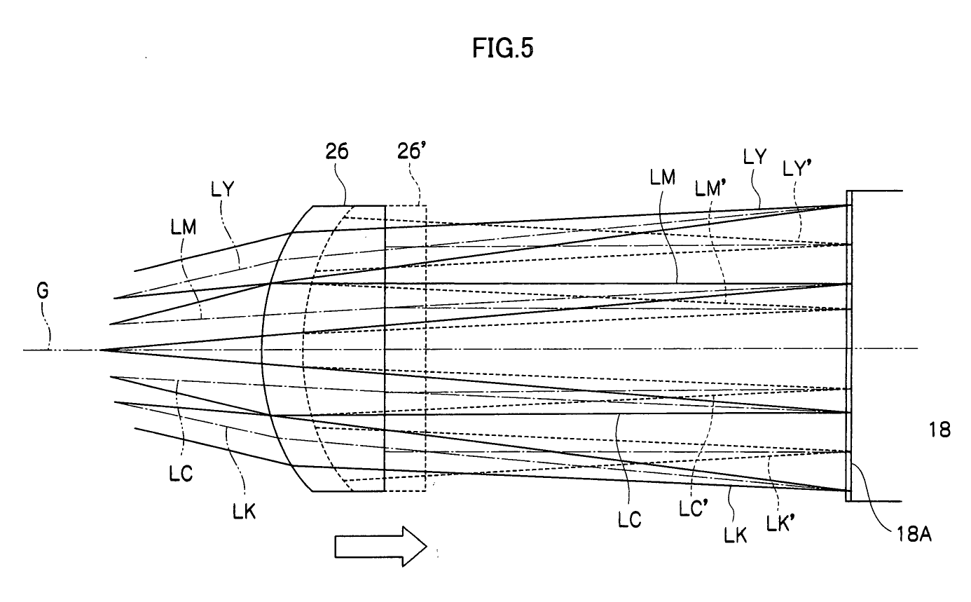

As shown in FIG. 5, the cylindrical lens 26 is movable in parallel with the direction of an optical axis G. Hence, as is shown in FIG. 5, by moving the cylindrical lens 26 in the direction of the optical axis Q it is possible to adjust a magnification ratio of the pre-deflection optical system 16. In addition, the state shown by solid lines, in which sub-scanning direction incidence angles of the laser beam groups LY-K onto the deflection surface 18A of the rotating polygon mirror 18 diverge, changes such that main optical axes of the respective laser beam groups LY-K become parallel, as shown by the broken lines. Note that FIG. 5 is schematically, exaggeratedly illustrated.

Further, as shown in FIGS. 1 and 2, a pitch of the laser beams L can be adjusted by adjusting an angle of the light source 14 about the optical axis G.

Next, a cylindrical lens-moving mechanism 100, which moves the cylindrical lens 26 in parallel with the optical axis G direction, will be described.

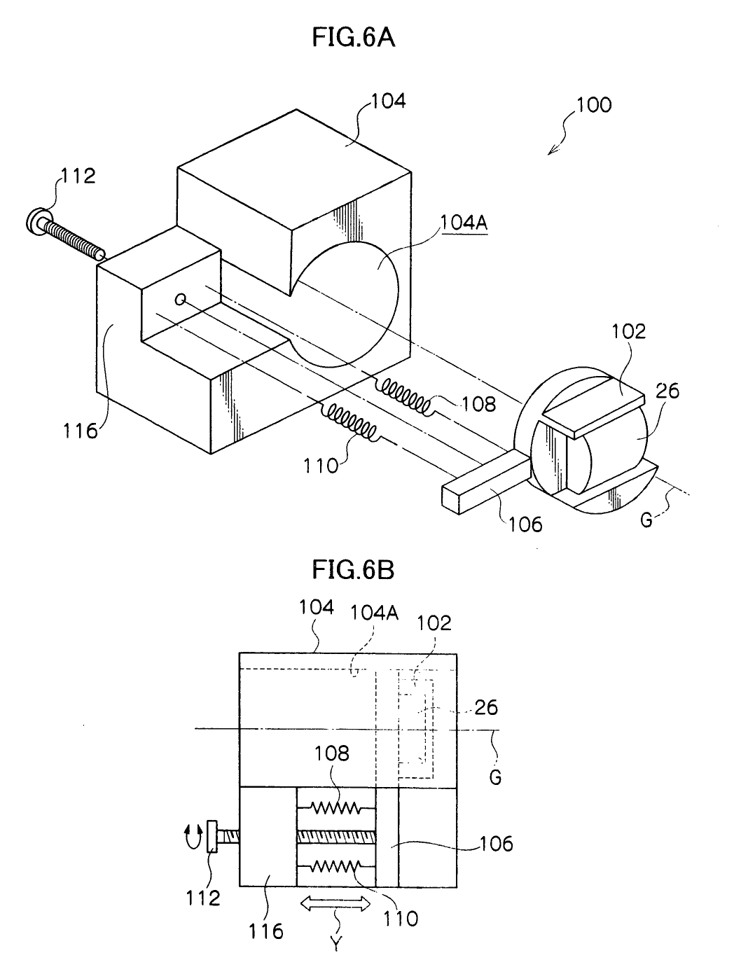

As shown in FIG. 6A, the cylindrical lens 26 is mounted at a lens holder 102. The lens holder 102 is fitted in, to be movable in the optical axis G direction, at a cylinder-form insertion portion 104A of a lens holder-mounting member 104. An arm portion 106 is formed at the lens holder 102. As shown in FIG. 6B, the arm portion 106 is pulled on by tension coil springs 108 and 110, and abuts against a distal end of a screw 112. The screw 112 is threadingly engaged with an attachment portion 116 of the lens holder-mounting member 104. Hence, when the screw 112 turns, the distal end of the screw 112 moves along the optical axis G direction, and the arm portion 106 moves accordingly in the optical axis G direction as shown by the arrow Y. With this movement, the mechanism moves the lens holder 102, and thus the cylindrical lens 26, in the direction of the optical axis G.

Next, a light source-turning mechanism 150, which turns the light source 14 about the optical axis G, will be described.

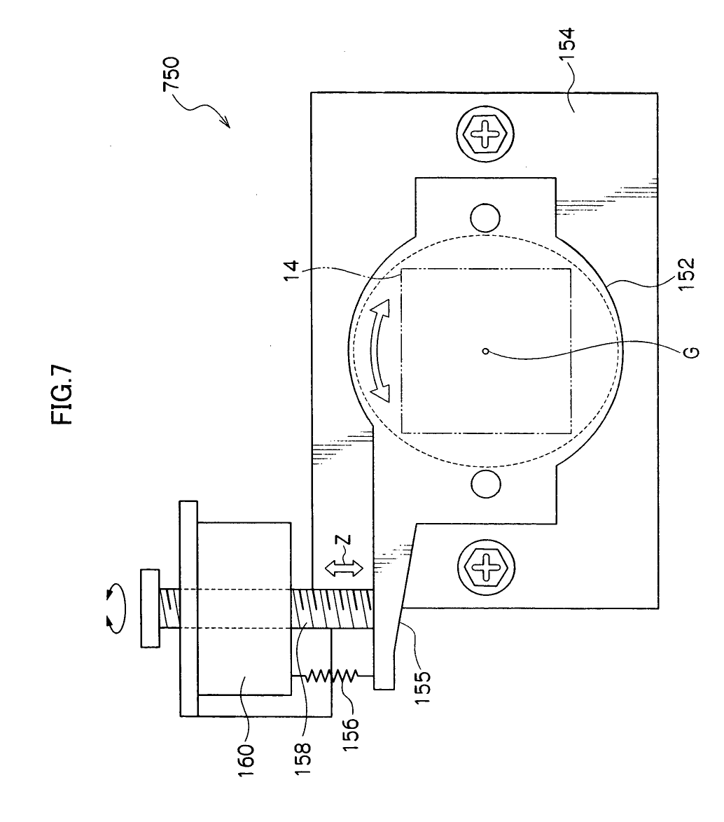

As shown in FIG. 7, the light source 14 is mounted at a bracket 152, amd the bracket 152 is mounted, to be rotatable about the optical axis G, at a bracket-mounting member 154. An arm portion 155 is formed at the bracket 152. The arm portion 155 is pulled on by a tension coil spring 156, and abuts against a distal end of a screw 158. The screw 158 is threadingly engaged with an attachment portion 160. Hence, when the screw 158 turns, the distal end moves up/down, and the arm portion 155 accordingly moves up/down as shown by the arrow Z. Because of this vertical movement, the mechanism turns (swivels) the bracket 152, and thus the light source 14, about the optical axis G.

Note that the cylindrical lens-moving mechanism 100 and the light source-turning mechanism 150 may have, rather than structures in which the screws 112 and 158 are manually turned, structures in which stepper motors and the like are employed, and may have further different structures. That is, it is sufficient that there be structures which are capable of moving the cylindrical lens 26 in the optical axis G direction and capable of turning the light source 14 about the optical axis G.

Next, operations of this exemplary embodiment will be described.

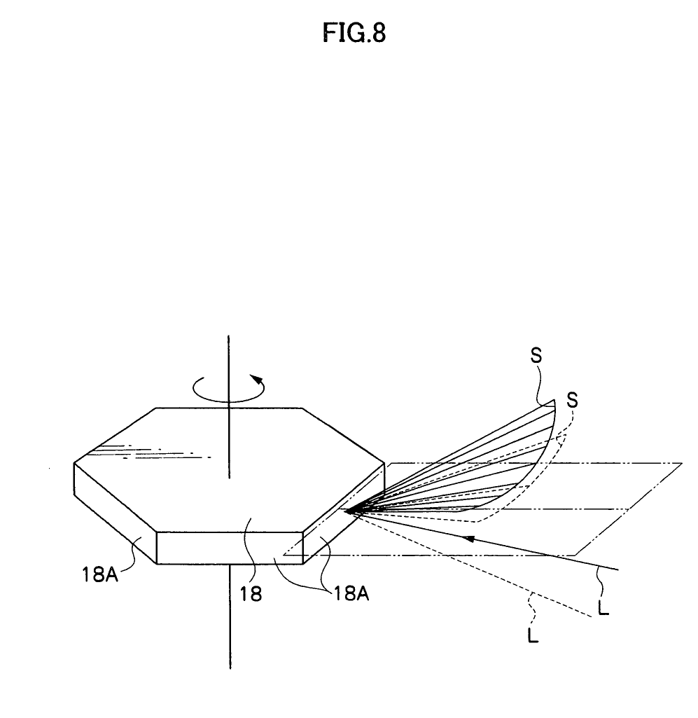

As shown in FIG. 8, when a laser beam L is incident on the deflection surface 18A of the rotating polygon mirror 18 at an incline in the sub-scanning direction, a curved scanning line S will be formed at the respective photosensitive body 12. Further, a curvature amount varies with this incidence angle.

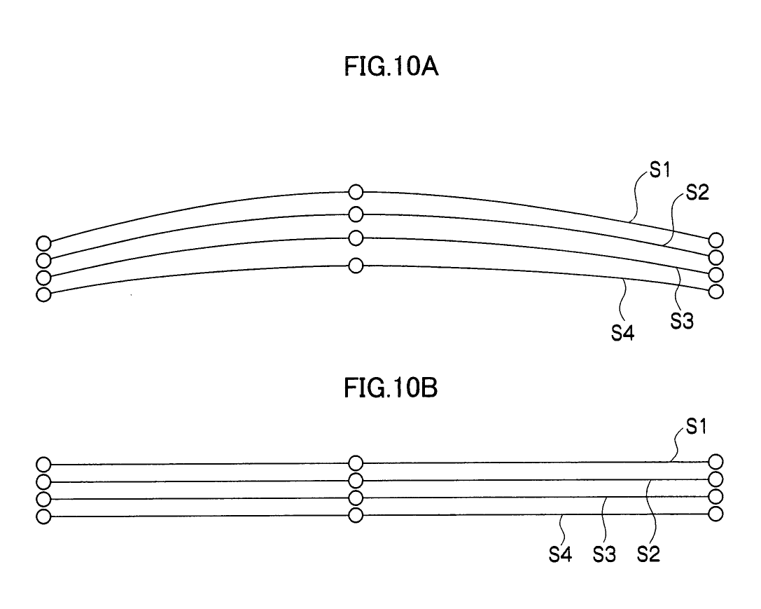

Now, with the optical scanning apparatus 10 as in this exemplary embodiment, in which the plural laser beams L emitted from the single light source 14, at which the light emission points P are two-dimensionally arranged in the grid form, are separated and plural scanning lines S are simultaneously formed at each of the plural photosensitive bodies 12, as shown in FIG. 1, etc., if the sub-scanning direction incidence angles of the laser beam groups LY-K on the deflection surface 18A of the rotating polygon mirror 18 differ, degrees of curvature of the scanning lines S at each photosensitive body 12 differ and form color offsets. Further, because sub-scanning direction incidence angles on the deflection surface 18A of the rotating polygon mirror 18 also differ within the plural laser beams L that scan one photosensitive body 12, degrees of curvature of the scanning lines S that are formed by this plurality of laser beams L differ, as shown in FIG. 10A, and a pitch between the laser beams L on the photosensitive body 12, that is, a spacing of scanning lines S1 to S4, varies between central portions and respective end portions. In other words, sub-scanning direction spacings of the scanning lines vary with main scanning direction scanning positions, and a bow difference occurs.

Note that although there are actually eight of the scanning lines S in this exemplary embodiment, in order to facilitate comprehension, only four scanning lines, scanning line S1 to scanning line S4, are illustrated in FIGS. 10A and 10B, and descriptions are given in accordance with the drawings. Further, other drawings may also be illustrated with suitable omissions, with descriptions being given in accordance with the drawings.

Anyway, conventionally, a “tangle error correction optical system” featuring power in a sub-scanning direction has been provided subsequent to scanning deflection (that is, subsequent to the rotating polygon mirror 18), and curvature amounts of scanning lines have been made substantially equal by curving a generating line of this correction optical system to moderate a color offset.

However, such a method cannot correct within plural laser beams that are scanning the same photosensitive body, and portions at which sub-scanning direction spacings of the scanning lines are different would arise (i.e., a bow difference occurs). With a tangle error correction optical system, although a degree of bow difference is moderated, because the deflection surface of the rotating polygon mirror and the photosensitive body which is a scanning-object surface have a conjugative relationship, the bow difference is not reduced to zero. When a magnification ratio (a coupling magnification) of the conjugative relationship is of an enlarging type (i.e., a lateral magnification ratio is greater than 1), curvature amounts of the respective scanning lines differ remarkably, and sub-scanning direction spacings of the scanning lines differ. In such a case, even when a predetermined angle is provided to the light source to adjust a scanning line pitch, as in Japanese Patent Application (JP-A) No. 2004-276532, scanning line spacings will not be equal over the whole surface of the photosensitive body 12 (i.e., the bow difference cannot be eliminated). Consequently, density differences due to pitch variations of the scanning lines occur.

The main factors behind such occurrences are due to focusing distance errors of the respective optical systems, mechanical mounting accuracies and the like. For example, in this exemplary embodiment, if a curvature of the cylindrical lens 26 differs by 1%, incidence angles on the rotating polygon mirror 18 change by 0.01° and inter-beam spacings change by about 1 μm.

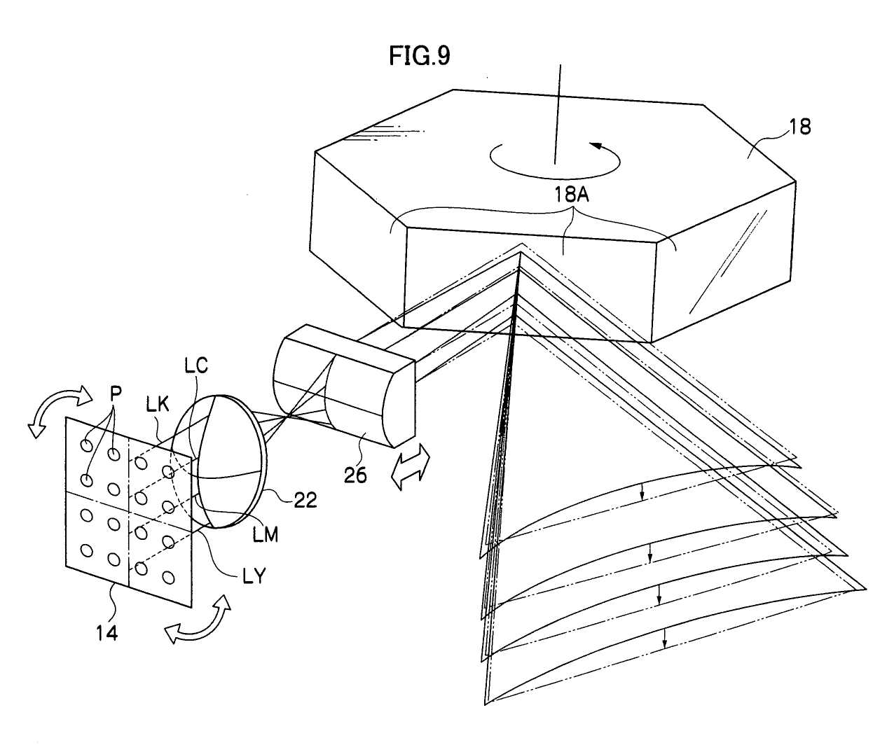

Accordingly, in this exemplary embodiment, as shown in FIGS. 5 and 9, by moving the cylindrical lens 26 in the optical axis G direction to adjust the magnification and adjusting such that the sub-scanning direction incidence angles of the laser beam groups LY-K at the deflection surface 18A of the rotating polygon mirror 18 are substantially perpendicular with respect to the deflection surface (i.e., such that the laser beam groups LY-K are substantially parallel to one another), the curvature amounts of the scanning lines S are reduced and are made substantially equal. Further, by rotating the light source 14 about the optical axis G, pitch of the scanning lines S is adjusted.

As a result of such adjustments, as shown in FIGS. 10A and 10B, bowing of the scanning lines S is substantially eliminated (curvature amounts of the scanning lines S become substantially equal), and sub-scanning direction spacings become substantially equal regardless of main scanning direction scanning positions. That is, the spacings of the scanning lines are substantially equal in the sub-scanning direction over the whole surface of the photosensitive body 12.

In other words, “bowing” and “bow differences” are eliminated, and as a result, color shifts and density variations are eliminated.

Next, an optical scanning apparatus 200 of a second exemplary embodiment of the present invention will be described.

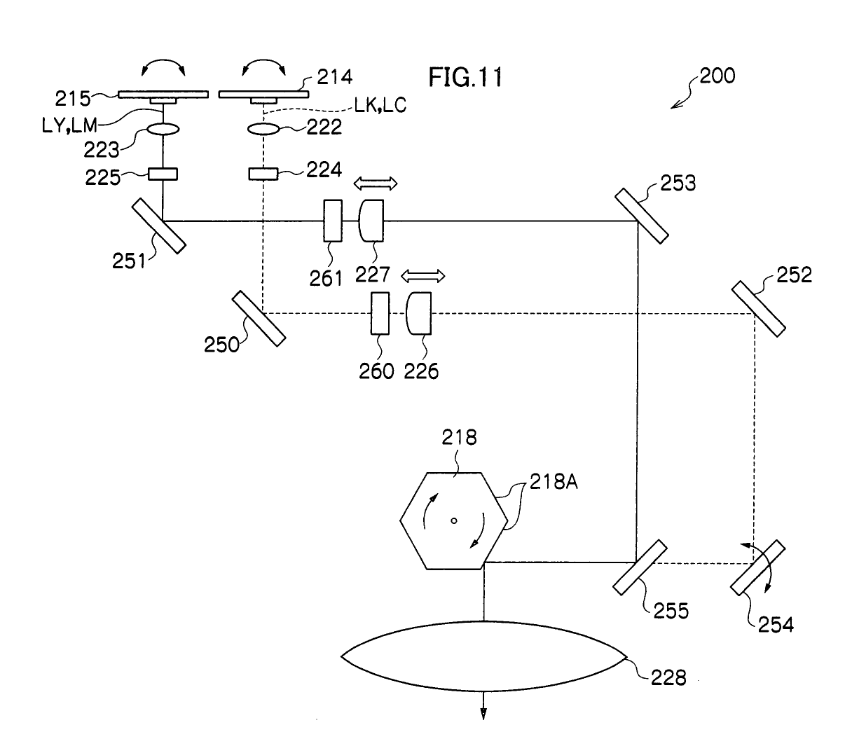

As shown in FIG. 11, the optical scanning apparatus 200 is provided with two light sources 214 and 215, at which point light sources P are two-dimensionally arranged in grid forms similarly to the first exemplary embodiment (i.e., two light sources are provided). Note that FIG. 11 is schematically drawn and does not accurately show actual arrangements of the various members.

Laser beam groups LK and LC, which are constituted by pluralities of laser beams L emitted from the light source 214, are condensed by a coupling lens 222, pass through an aperture 224 while being truncated, and are then reflected by a reflection mirror 250. After being reflected, the laser beam groups LK and LC are condensed by a lens 260 and a cylindrical lens 226 only in a direction corresponding to the sub-scanning direction, are reflected by reflection mirrors 252 and 254, and are then incident at a deflection surface 218A of a rotating polygon mirror 218.

Similarly, laser beam groups LY and LM, which are constituted by pluralities of laser beams L emitted from the light source 215, pass through a coupling lens 223 and an aperture 225, and are then reflected by a reflection mirror 251. The laser beam groups LY and LM are condensed by a lens 261 and a cylindrical lens 227 only in a direction corresponding to the sub-scanning direction, are reflected by reflection mirrors 253 and 255, and are then incident at the deflection surface 218A of the rotating polygon mirror 218.

Here, the laser beam groups LK and LC emitted from the light source 214 and the laser beam groups LY and LM emitted from the light source 215 are incident at the same deflection surface 218A of the same rotating polygon mirror 218. Hence, after being scanningly deflected by the rotating polygon mirror 218, the laser beam groups LK, LC, LY and LM pass through an f-θ lens 228, etc., and are then focused at the respective photosensitive bodies 12.

Similarly to the first exemplary embodiment, the light source 214 and light source 215 turn about optical axes thereof, and the cylindrical lenses 226 and 227 move in parallel with the optical axis directions.

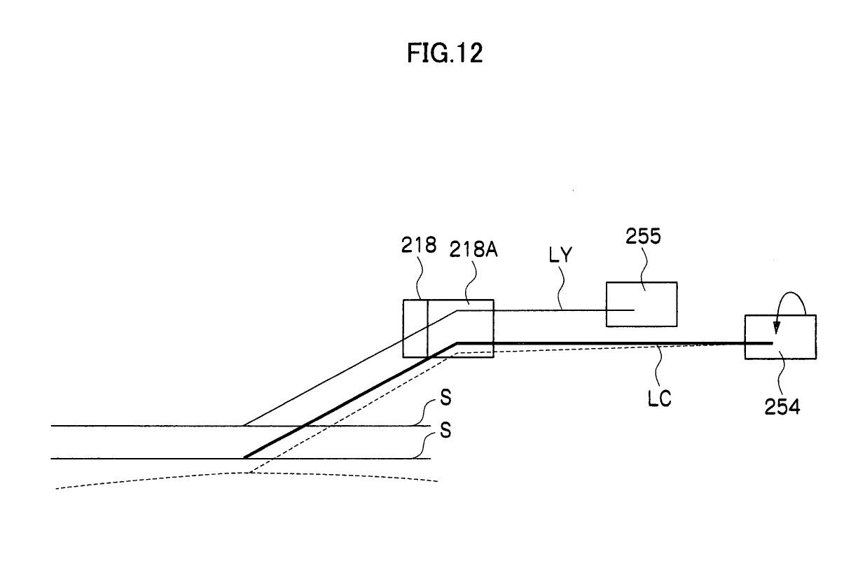

Further, as shown in FIG. 12, the reflection mirror 254 can turn about an axis which intersects the sub-scanning direction, and sub-scanning direction incidence angles at which the laser beam groups LK and LC emitted from the light source 214 are incident at the deflection surface 218A of the rotating polygon mirror 218 can be adjusted. Note that only the laser beam groups LY and LC are illustrated in FIG. 12.

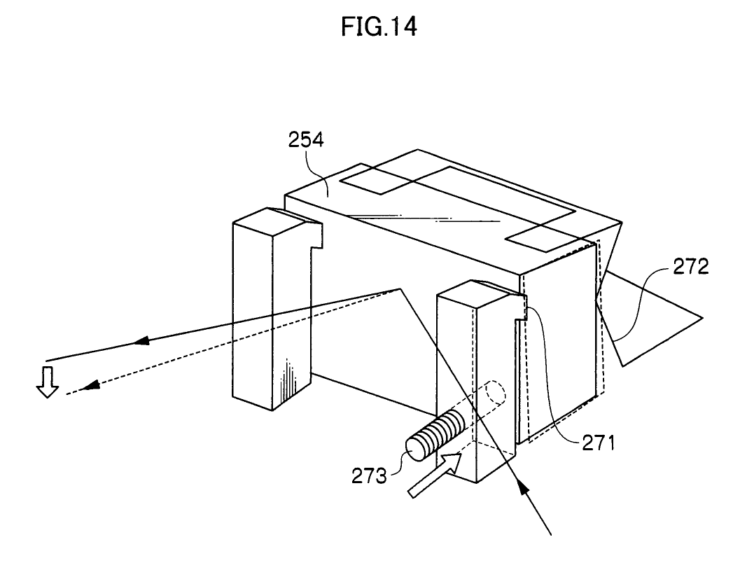

An incidence angle-adjusting mechanism of the reflection mirror 254 is shown in FIG. 14. A mounting reference surface 271 is provided at an unillustrated casing body. The reflection mirror 254 is pushed, from a rear face of the reflection mirror 254, against the mounting reference surface 271 by a spring 272. An adjustment screw 273 is provided at a lower portion of one side of the mounting reference surface 271. When the adjustment screw 273 is turned, the adjustment screw 273 pushes a lower portion of the mirror, and the reflection mirror 254 can be altered to a downward-facing angle.

The incidence angles of the laser beam groups LK and LC on the deflection surface 218A are altered by this mechanism. Note that this incidence angle-adjusting mechanism is not necessarily limited to the present mode, and could be, for example, a structure for turning a mirror holder in a state in which the reflection mirror 254 is retained at the mirror holder.

Next, operations of this second exemplary embodiment will be described.

In this exemplary embodiment, when the reflection mirror 254 is turned, as shown in FIG. 12, sub-scanning direction incidence angles at which the laser beam groups LK and LC emitted from the light source 214 are incident on the deflection surface 218A of the rotating polygon mirror 218 are adjusted, and are made substantially equal to incidence angles of the laser beam groups LY and LM emitted from the light source 215. As a result, bow differences between the laser beam groups emitted from the light source 214 and the light source 215 can be substantially eliminated.

Next, an optical scanning apparatus 300 of a third exemplary embodiment will be described.

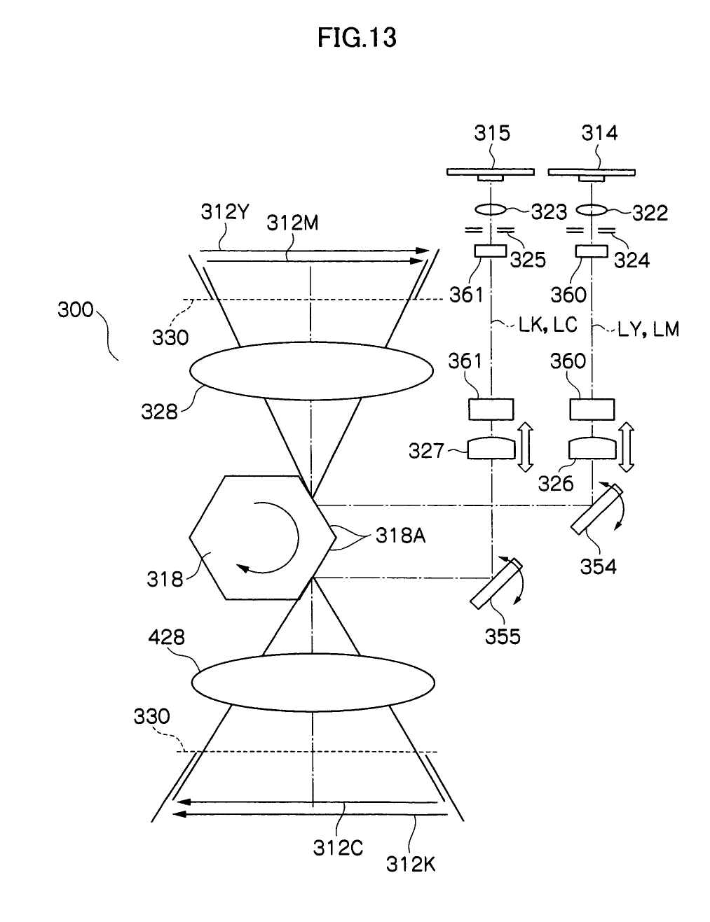

As shown in FIG. 13, the optical scanning apparatus 300 is provided with two light sources 314 and 315, at which point light sources P are two-dimensionally arranged in grid forms similarly to the first exemplary embodiment (i.e., two light sources are provided). Note that FIG. 13 is schematically drawn and does not accurately show actual arrangements of the various members.

Laser beam groups LK and LC, which are constituted by pluralities of laser beams L emitted from the light source 315, are condensed by a coupling lens 323 and pass through an aperture 325 while being truncated. The laser beam groups LK and LC are then condensed by a lens 361 and a cylindrical lens 327 only in a direction corresponding to the sub-scanning direction, are reflected by a reflection mirror 355, and are then incident at deflection surfaces 318A of a rotating polygon mirror 318. After being scanningly deflected by the rotating polygon mirror 318, the laser beam groups LC and LK pass through an f-θ lens 428 or the like, and are then separated between LK and LC by a separation mirror 330. Thereafter, the laser beam groups LK and LKC are focused at photosensitive bodies 312K and 312C, respectively.

Similarly, laser beam groups LY and LM, which are constituted by pluralities of laser beams L emitted from the light source 314, are condensed by a coupling lens 322 and pass through an aperture 324 while being truncated. The laser beam groups LY and LM are then condensed by a lens 360 and a cylindrical lens 326 only in a direction corresponding to the sub-scanning direction, are reflected by a reflection mirror 354, and are then incident at the deflection surfaces 318A of the rotating polygon mirror 318. After being scanningly deflected by the rotating polygon mirror 318, the laser beam groups LY and LM pass through an f-θ lens 328 or the like, and are then separated between LY and LM by another of the separation mirror 330. Thereafter, the laser beam groups LY and LM are focused at photosensitive bodies 312Y and 312M, respectively.

Now, as can be seen from FIG. 13, the laser beam groups LY and LM emitted from the light source 314 are incident at one of the deflection surfaces 318A, which differs in facing from another of the deflection surfaces 318A at which the previously described laser beam groups LK and LC emitted from the light source 315 are incident.

Further, the light source 314 and the light source 315 turn about optical axes thereof. By moving the cylindrical lenses 326 and 327 along the optical axis directions, it is possible to adjust relative differences between sub-scanning direction incidence angles at the deflection surfaces 318A of the laser beam groups LK and LC and the laser beam groups LY and LM. Furthermore, similarly to the second exemplary embodiment, the reflection mirror 354 can turn about an axis which intersects the sub-scanning direction, and sub-scanning direction incidence angles of the laser beam groups LY and LM emitted from the light source 314 can be adjusted relative to sub-scanning direction incidence angles at which the laser beam groups LK and LC are incident at the deflection surfaces 318A of the rotating polygon mirror 318 (see FIG. 12).

The present embodiment implements similar operations to the first exemplary embodiment and the second exemplary embodiment, so descriptions thereof will not be given.

1. An optical scanning apparatus comprising:
a light source, which emits a plurality of light beam groups from a plurality of liminous points which are two-dimensionally arranged in a grid form;
a pre-deflection optical system, which transmits the plurality of light beam groups emitted from the light source; and
a deflector, which reflects the plurality of light beam groups which have been transmitted through the pre-deflection optical system at a deflection surface, for scanningly deflecting the plurality of light beam groups in a main scanning direction,
wherein the pre-deflection optical system includes a first incidence angle-adjuster, for adjusting sub-scanning direction incidence angles of the light beam groups which are incident at the deflection surface of the deflector.

2. The optical scanning apparatus of claim 1, wherein the light source comprises an angle-adjuster, for turning the light source about an optical axis thereof and adjusting an angle of the light source.

3. The optical scanning apparatus of claim 1, wherein a plurality of the light source and a plurality of the pre-deflection optical system are provided, the plurality of pre-deflection optical systems including the respective first incidence angle-adjusters, and
the pluralities of light beam groups emitted from the plurality of light sources and transmitted through the plurality of pre-deflection optical systems are scanningly deflected by one of the deflector.

4. The optical scanning apparatus of claim 3, wherein at least one of the light beam groups emitted from the plurality of light sources is reflected and scanningly deflected at one face of the one deflector, and each other of the light beam groups is reflected and scanningly deflected at another face of the one deflector.

5. The optical scanning apparatus of claim 3, wherein at least one of the plurality of pre-deflection optical systems comprises, in addition to the first incidence angle-adjuster:
a second incidence angle-adjuster, for adjusting incidence angles of the light beam groups that are transmitted through the at least one pre-deflection optical system, such that a sub-scanning direction incidence angle at which another of the light beam groups, which is emitted from another of the light sources, is incident at the deflector and the incidence angles of the light beam groups are substantially equal.

6. The optical scanning apparatus of claim 5, wherein at least one of the light beam groups emitted from the plurality of light sources is reflected and scanningly deflected at one face of the one deflector, and each other of the light beam groups is reflected and scanningly deflected at another face of the one deflector.

7. The optical scanning apparatus of claim 1, wherein the pre-deflection optical system comprises a cylindrical lens without power in the main scanning direction and with power in the sub-scanning direction, and
sub-scanning direction incidence angles at which the light beam groups are incident at the deflection surface are adjusted by moving the cylindrical lens in an optical axis direction.
